(19) United States
(12) Patent Application Publication
(10) Pub. No.: US 2022/0256867 A1
(43) Pub. Date: Aug. 18, 2022

(54) NATAMYCIN IN A BAKED PRODUCT

(71) Applicant: DSM IP ASSETS B.V., Heerlen (NL)

(72) Inventors: Judith Corine VAN PEIJ-VISSER, Echt (NL); Dirk VAN DEN BERG, Echt (NL); Ben Rudolf DE HAAN, Echt (NL)

(21) Appl. No.: 17/628,722

(22) PCT Filed: Jul. 23, 2020
(86) PCT No.: PCT/EP2020/070816

§ 371 Date: Jan. 20, 2022

(30) Foreign Application Priority Data
Jul. 25, 2019 (EP) 19188340.4

(51) Int. Cl. A21D 2/18; A21D 10/00

(52) U.S. Cl. CPC A21D 2/18; A21D 13/45; A21D 10/00

(57) ABSTRACT

The present invention relates to a process for preparing a non-yeast baked product comprising
i. preparing a dough comprising adding a composition comprising natamycin having needle shaped crystals to the dough wherein the mean length of the needle shaped crystals is from 0.1 to 20 μm; and
ii. baking the dough.

### FIELD

The present invention relates to a process for preparing a non-yeast baked product wherein natamycin is used and a non-yeast baked product comprising natamycin.

### BACKGROUND

Baked products typically emerge from the baking process with a sterile surface. However, post bake handling can quickly lead to fungal surface contamination through exposure to air borne contaminants as well as equipment contact. Non-yeast baked products with a relatively neutral pH, high moisture content and high water-activity such as pancakes, cakes, muffins, pastry, waffles, and tortillas are particularly prone to rapid spoilage from a variety of moulds, like Aspergillus, Cladosporium and Penicillium species. The manufacture of good tasting, high moisture baked products that have a long mould-free shelf life is an ongoing challenge.

For many decades, the polyene macrolide antimycotic natamycin has been used to prevent fungal growth on food products, initially products such as cheeses and sausages and later also beverages, crop, and fruit. This natural preservative, which is produced by fermentation using Streptomyces natalensis, is widely used as a food preservative and has a long history of safe use. Natamycin has not been reported to have any adverse quality or flavor impact on food products.

The use of natamycin for the preservation of a baked product has also been described.

WO2006/045831 discloses natamycin needle shaped crystals and the use of the natamycin needle shaped crystals to preserve all kinds of food products such as hot-baked flour products. WO2006/045831 does not disclose that the natamycin needle shaped crystals are used in a baked product.

EP1382261 discloses a bread product that can be stored under refrigerated temperatures for extended periods of time and a bread recipe is disclosed comprising a microbial inhibitor in an amount of 0.2 to 1% flour basis. The microbial inhibitor may be included in the dough and/or applied to the exterior surface of the bread product after baking. Several microbial inhibitors are listed, for example natamycin, and calcium propionate and potassium sorbate are the preferred microbial inhibitors in the bread product of EP1382261.

WO2005/074690 discloses that when natamycin was incorporated into the dough of tortilla and pastry dough the shelf life of the baked product was not significantly improved and mould growth on the surface still occurred. The preparation of mooncakes was disclosed, wherein natamycin was added in an amount of 20, 25, 30 and 35 ppm to the pastry dough, and mould spoilage still occurred after 20 to 24 days of storage. Natamycin is heat sensitive to the high temperatures used in baking and loses antifungal activity during the baking process. WO2005/074690 discloses that application of aqueous natamycin (Natamax™ lactose in water) on the surface of a non-yeast leavened baked product could prevent mould growth on the baked product for up to 70 days.

A problem related to applying a natamycin solution or suspension onto a baked product for instance by spraying is the wetting of the surface of the baked product by the solvent. An increased moisture content of the surface of a baked product may be detrimental to the crispy crust and/or mouthfeel of a baked product and the baked product can become sticky. For instance, flat breads like tortillas or pancakes can stick together when stacked in a packaging such as a plastic bag when the surface of the flat breads is too moist.

WO2008/110531 discloses a process for increasing the shelf life of a baked product by spraying the baked in two directions with a natamycin solution and subsequently removing the sprayed natamycin solvent from the surface, for instance by heat, blowing or microwaves.

CN102805130 discloses a method for preventing high moisture content in cake and maintaining fresh cake by adding sodium dehydroacetate, sorbic acid and glucose-δ-ficusin into flour, and after baking and cooling the cake and before the cake is put into a packaging bag, spraying a natamycin suspension liquid onto the surface of the cake and inner side of the packaging bag.

There is a need for an improved method for preparing a non-yeast baked product with a good shelf life.

### SUMMARY

The present invention relates to a process for preparing a non-yeast baked product comprising
i. preparing a dough comprising adding a composition comprising natamycin having needle shaped crystals to the dough wherein the mean length of the needle shaped crystals is from 0.1 to 20 μm; and
ii. baking the dough.

The invention further relates to a non-yeast baked product obtainable by a process as disclosed herein.

The invention also relates to a packaging comprising the non-yeast baked product as disclosed herein.

The invention also relates to a non-yeast dough and a method for preparing a non-yeast dough comprising a composition comprising natamycin having needle shaped crystals to the dough wherein the mean length of the needle shaped crystals is from 0.1 to 20 μm.

The invention also relates to the use of a composition comprising natamycin having needle shaped crystals to improve the shelf life of a non-yeast baked product wherein the mean length of the needle shaped crystals is from 0.1 to 20 μm, and wherein the composition is present in the non-yeast baked product.

### DETAILED DESCRIPTION

The present invention relates to a process for preparing a non-yeast baked product comprising
i. preparing a dough comprising adding a composition comprising natamycin having needle shaped crystals to the dough wherein the mean length of the needle shaped crystals is from 0.1 to 20 μm; and
ii. baking the dough.

Surprisingly, it was found that a non-yeast baked product prepared in a process wherein a composition comprising natamycin needle-shaped crystals as disclosed herein was added into the dough did not show fungal spoilage for at least 7 days, or at least 11 days of storage, or at least 15, 21, 29, 36 or at least 45 days of storage. It was surprisingly found that baking the dough comprising natamycin needle shaped crystals did not degrade the natamycin, or did not degrade all natamycin in the dough, or did not degrade all antifungal activity of the natamycin, so fungal spoilage of the baked product prepared from the dough was prevented, in particular fungal spoilage on the surface of the baked product was prevented after prolonged storage, such as for at least 7 days, or at least 11 days of storage, or at least 15, 21, 29, 36 or at least 45 days of storage.

A non-yeast baked product is defined herein as a baked product wherein no yeast is used during the preparation of the baked product. A non-yeast baked product may be a non-leavened baked product or non-yeast leavened baked product that had been leavened, for instance by the presence of baking powder. A non-yeast baked product as disclosed herein may be a cake, a muffin, a pastry, a waffle, and/or a flat bread. A flat bread may for instance be a pancake, a chemically leavened pizza or a tortilla. Preferably a non-yeast baked product is a cake, or a flat bread, preferably a tortilla. The cake may be a sponge cake. Preferably, cake is not mooncake, for instance not a mooncake as disclosed in the reference example of WO2005/074690, on p. 7.

The non-yeast baked product usually has a water activity (a_{w}) of 0.80 to 0.99, such as an a_{w} of 0.82 to 0.96, such as an a_{w} of 0.84 to 0.94.

A process for preparing a non-yeast baked product as disclosed herein comprises preparing a dough. Dough disclosed herein is a non-yeast dough and is defined herein as a mixture of (cereal) flour and other ingredients, such as water, eggs, salt, sugar and/or butter. Usually, dough is firm enough to knead or roll. The dough may be fresh, frozen, or parbaked. Dough for preparing a non-yeast baked product as disclosed herein may comprise a chemical leavening agent, such as a combination of an acid (generating compound) and bicarbonate. Cereals from which flour can be made include maize, rice, wheat, barley, sorghum, millet, oats, rye, triticale, buckwheat, quinoa, spelt, einkorn, emmer, durum and kamut. Flour may also be made from tapioca. A dough as disclosed herein may further comprise suitable baking enzymes such as amylase, xylanase or lipase.

The term dough herein also includes a batter. A batter is a semi-liquid mixture, being thin enough to drop or pour from a spoon, of one or more flours combined with liquids such as water, milk and eggs used to prepare various foods, including cake. A person skilled in the art knows how to prepare a dough to prepare a non-yeast baked product.

Preparing a dough in a process for preparing a non-yeast baked product as disclosed herein comprises adding a composition comprising natamycin having needle shaped crystals to the dough wherein the mean length of the needle shaped crystals is between 0.1 and 20 μm. Needle shaped crystals of natamycin as disclosed herein can be, or are prepared according to the methods disclosed in Example 1 and Example 2 of WO2006/045831. The natamycin needle shaped crystals disclosed herein comprise at least 60% needle shaped crystals having a length of more than 2 μm. The natamycin needle shaped crystals disclosed herein have a mean diameter of 0.1 to 2 μm, and at least 60% of the needle shaped crystals may have a diameter of less than 2 μm. By “length” and “diameter” is meant the length and diameter as measured with an (Olympus) microscope (type BH-2) with a total used magnification of 1000 times, whereby the length is the largest length size of the crystal and the diameter is the size of the thickness of the crystal measured in the middle of the length and perpendicular to the length direction. The mean length and the mean diameter are both determined by measuring at least 100 crystals as disclosed in WO2006/045831. The natamycin in a composition as disclosed herein comprises at least 50 w/w %, 60 w/w %, 70 w/w %, 80 w/w %, 90 w/w %, or at least 95% w/w of needle shaped crystals.

The composition comprising natamycin having needle shaped crystals as disclosed herein may be added to the dough in a suitable way known to a person skilled in the art, for instance by mixing, stirring or kneading. The composition comprising natamycin is added to the dough such that an amount of 1 to 50 ppm, for instance an amount of 2 to 45 ppm, or 5 to 40 ppm, for instance 8 to 35 ppm, for instance 10 to 30 ppm of natamycin is added to the dough. The amount of natamycin in ppm is relative to the total weight of the dough. Accordingly, a non-yeast baked product as disclosed herein comprises an amount of 1 to 50 ppm, for instance an amount of 2 to 45 ppm, or 5 to 40 ppm, for instance 8 to 35 ppm, for instance 10 to 30 ppm of natamycin in the baked product.

The composition comprising natamycin that is added to the dough may be a liquid or a dry composition, for instance, the composition may be a water-containing suspension comprising natamycin. The composition comprising natamycin having needle-shaped crystals as disclosed herein comprises from 1 to 10 wt % of natamycin, such as from 2 and 8 wt % of natamycin, such as from 3 to 6 wt % of natamycin. The composition comprising natamycin having needle-shaped crystals may further comprise xanthan and/or carboxymethylcellulose (CMC). Xanthan and/or CMC may be present in a water-containing suspension comprising natamycin to improve stability of the suspension.

Surprisingly, it was found that a non-yeast baked product prepared in a process as disclosed herein has a shelf life of at least 7 days. Shelf life is defined herein as the length of time during which the baked product prepared in a process as disclosed herein remains free of fungal spoilage. Free of fungal spoilage includes free of mould growth. Fungal spoilage means that growth of fungi including moulds is determined visually on the surface of the baked product. Preferably, the non-yeast baked product prepared in a process as disclosed herein has a shelf life of at least 11, 15, 21, 24, 29, 36, 39 or at least 43 or 45 days. In addition, it was found that the surface of a non-yeast baked product prepared in a process as disclosed herein exhibited a less sticky and less moist surface as compared to baked products that were sprayed or dipped with a natamycin solution on the surface of the baked products.

A process for preparing a non-yeast baked product further comprises baking the dough. Baking of a non-yeast baked product may be performed in an oven at a temperature of between 150° C. and 250° C., for instance a temperature of between 180° C. and 220° C. known to a person skilled in the art. Baking the dough may also be performed in a baking pan, for instance for the preparation of flat breads such pancakes or tortillas. Surprisingly, it was found that baking the dough did not degrade the natamycin needle shaped crystals or all natamycin needle shaped crystals in the dough, or did not inactivate the antifungal effect of the natamycin needle shaped crystals, and therefore fungal spoilage of the baked product prepared in a process as disclosed herein was prevented for at least 7, 11, 15, 21, 24, 28, 29, 30, 36, 39 or at least 43 or 45 days.

Optionally, preparing the non-yeast baked product may further comprise cutting the non-yeast baked product into slices by methods known in the art. Cutting a non-yeast baked product such as cake is usually performed before packaging the baked product.

The process for preparing a non-yeast baked product may further comprise packaging the baked product. Packaging a non-yeast baked product may be performed by any suitable methods known in the art. The non-yeast baked product may be packaged in a plastic bag directly or under a protective atmosphere. Flat breads, such as pancakes or tortillas are usually stacked, for instance a number of 2 to 20 flatbreads are stacked and then put together in a plastic bag or plastic envelope. Surprisingly, it was found that flat non-yeast baked products prepared in a process as disclosed herein, such as flat breads showed reduced stickiness when stacked together and packaged as compared to flat non-yeast baked products that were treated on the surface with natamycin, for instance by spraying or dipping.

Also disclosed herein is a process for improving the shelf life of a non-yeast baked product comprising
i. preparing a dough comprising adding a composition comprising natamycin having needle shaped crystals to the dough wherein the mean length of the needle shaped crystals is from 0.1 to 20 μm; and
ii. baking the dough.

All features for a process for preparing a non-yeast baked product disclosed herein above are applicable for a process for improving the shelf life of a non-yeast baked product. The present invention also relates to a non-yeast baked product obtainable by a process as disclosed herein. Surprisingly it was found that the non-yeast baked product has a shelf life of at least 7 days, for instance a shelf life of at least 11, 15, 21, 24, 28, 29, 30, 36, 39 or at least 43 or 45 days. In addition, it was found that a non-yeast baked product prepared in a process as disclosed herein exhibited a less sticky and less moist surface as compared to baked products that were sprayed with a natamycin solution or suspension.

Accordingly, also disclosed herein is a non-yeast baked product comprising natamycin having needle shaped crystals in the baked product, wherein the mean length of the needle shaped crystals is from 0.1 to 20 μm, wherein the baked product has a shelf life of at least 7 days, such as a shelf life of at least 11, 15, 21, 29, 36, 39 or at least 45 days. The non-yeast baked product disclosed herein, is a non-yeast baked product which does not comprise natamycin that has been applied onto the surface of the baked product, for instance not natamycin that has been sprayed onto the surface of the baked product.

The non-yeast baked product s described herein above and may for instance be a cake, a muffin, a pastry, a waffle, and/or a flat bread for instance a pancake, a chemical leavened pizza, or a tortilla, preferably a cake, such as a sponge cake, or a tortilla. Preferably, cake is not mooncake, for instance not a mooncake as disclosed in the reference example of WO2005/074690, p. 7.

The present invention also relates to a packaging comprising the non-yeast baked product as disclosed herein or obtainable by a process for preparing the non-yeast baked product as disclosed herein. A suitable packaging comprising the non-yeast baked product may be a plastic bag or envelope made from any suitable material known to a person skilled in the art.

Also disclosed herein is a non-yeast dough comprising a composition comprising natamycin having needle-shaped crystals in the dough, wherein the mean length of the needle shaped crystals is from 0.1 to 20 μm. The non-yeast dough comprising a composition comprising natamycin having needle-shaped crystals in the dough is a dough wherein the natamycin having needle-shape crystals is homogenously distributed in the dough. A non-yeast dough as disclosed herein comprises an amount of 1 to 50 ppm, for instance an amount of 2 to 45 ppm, or 5 to 40 ppm, for instance 8 to 35 ppm, for instance 10 to 30 ppm of natamycin in the dough. The non-yeast dough as disclosed herein, is a dough which does not comprise natamycin that has been applied onto the surface of the dough, for instance that has been sprayed onto the surface

The invention further relates to a process for preparing a non-yeast dough comprising adding a composition comprising natamycin having needle-shaped crystals to the dough wherein the mean length of the needle shaped crystals is from 0.1 to 20 μm. Adding the composition comprising natamycin having needle-shaped crystals to the dough may be performed by methods known in the art for instance by mixing, stirring or kneading the composition comprising natamycin into the dough. Surprisingly, it was found that baking a dough comprising a composition comprising natamycin having needle shaped crystals wherein the mean length of the needle shaped crystals is from 0.1 to 20 μm resulted in a non-yeast baked product with an improved shelf life as disclosed herein. The process for preparing a non-yeast dough does not comprise spraying the surface of the dough with natamycin.

The present invention further relates to the use of a composition comprising natamycin having needle shaped crystals to improve the shelf life of a non-yeast baked product wherein the mean length of the needle shaped crystals is from 0.1 to 20 μm, and wherein the composition is present in the non-yeast baked product. An improved shelf life is defined herein as a shelf life of at least 7, 11, 15, 21, 24, 29, 36, 39 or at least 45 days. The shelf life of a non-yeast baked product in the use as disclosed herein is improved as compared to the shelf life of a non-yeast baked product comprising a composition of natamycin not comprising natamycin having needle shaped crystals wherein the mean length of the needle shaped crystals is from 0.1 and 20 μm.

Surprisingly it was found that when the composition comprising natamycin having needle shaped crystals as disclosed herein was present in the baked product, the stickiness of the baked product was reduced as compared to the stickiness of a baked product comprising natamycin that was sprayed on the surface. In one embodiment of the use as disclosed herein the baked product does not comprise natamycin that has been sprayed on the surface of the baked product.

All features disclosed herein above for a process for preparing a baked product are applicable for the non-yeast baked product, dough and process for preparing a dough and use as disclosed herein.

### EXAMPLES

### Materials

Delvo®Cid+ and Delvo®Cid Salt were available from DSM Food Specialties.
Delvo®Cid+07015 is a water-based suspension which comprises 4 wt % of needle-shaped natamycin prepared according to Example 1 or 2 in WO2006/045831 and 0.4% xanthan (Keltrol GM, 91-108%)
Delvo®Cid+07107 is a water-based suspension which comprises 4 wt % of needle-shaped natamycin prepared according to Example 1 or 2 in WO2006/045831 and 1.1% carboxymethyl cellulose (CMC, Walocel CTR 99.5%)
Delvo®Cid Salt is a powder of 50 wt % natamycin (irregular shaped crystals) and 50 wt % sodium chloride (NaCl)
Bakezyme® HSP 6000 (fungal xylanase), Bakezyme® P500 (fungal alpha amylase) and
Panamore® Golden (lipase) were also available from DSM Food Specialties.

### Determination of Moisture Content and Water Activity a_{w}

Moisture content of the baked products was determined in a Sartorius infrared moisture analyser MA 40 according to the instruction from the supplier.
Water activity a_{w} of the baked products was analysed in a LabMASTER-a_{w} by Novasine according the instructions from the supplier.

### Example 1. Shelf Life of Tortillas Prepared from Dough with Natamycin Needles in the Dough

Tortilla doughs were prepared by mixing the ingredients disclosed in Table 1 including one of the following preservatives: 0.3 w/w % calcium propionate, natamycin needles (Delvo®Cid+07015) or natamycin salt (Delvo®Cid salt, irregular shaped crystals), both dosed at 12 ppm based on total dough weight (20 ppm natamycin on flour weight). No preservative was added for the blanc.

TABLE 1
Ingredients of tortilla

| Raw material | g | Weight % |
|---|---|---|
| Wheat flour | 2000 | 59 |
| Water | 1080 | 31.8 |
| Salt | 30 | 0.9 |
| Fat (Biskien zacht) | 180 | 5.3 |
| Sodium Bicabonate | 16 | 0.5 |
| SAPP 28 | 28 | 0.8 |
| SSL | 10 | 0.3 |
| Dextrose | 40 | 1.2 |
| Sorbic acid | 4 | 0.1 |
| Fumaric acid | 4 | 0.1 |
| Bakezyme ® HSP6000 | 40 ppm | 0.002 |
| | (80 mg per 2 kg flour) | |
| Bakezyme ® P500 | 12.5 ppm | 0.00075 |
| | (25 mg/2 kg of flour) | |
| Panamore ® Golden | 20 ppm | 0.001 |
| | (40 mg/2 kg of flour) | |

The ingredients were kneaded into a dough ball using a Diosna spiral mixer while the temperature of the dough was kept at a temperature of 26° C. After 5 min of resting time at room temperature the dough ball was divided into balls of 60 g using a WP Haton Rotamat CN. The dough balls were covered with oil to prevent sticking to the plate, then left to proof for 8 to 10 min. After proofing the dough was pressed in a pizza press at 200° C. for 2.5 sec and then baked at 200° C. for 20 sec at one side, 40 sec at the other side and 20 sec at the first side. After baking, the tortillas were cooled at room temperature for 10 min and handled using gloves. The moisture content (%) and water activity (a_{w}) were determined after cooling and the values are shown in Table 2.

TABLE 2
Moisture content and water activity of tortillas
prepared with different preservatives

| | | | 20 ppm | |
|---|---|---|---|---|
| | | | Delvo ®Cid + | 20 ppm |
| | | 0.3% Ca- | 07015 | Delvo ®Cid |
| | Blanc | propionate | Natamycin needles | Natamycin salt |
| Moisture (%) | 25.8 | 27.8 | 24.5 | 25.2 |
| A_{w} | 0.93 | 0.93 | 0.92 | 0.92 |

Five tortillas were stacked and packed in a plastic bag and stored at room temperature. Mould growth was visually inspected in time without opening the bags.

The results in Table 3 show that no mould growth was observed on tortilla's prepared from dough with natamycin having needle-shaped crystals in the dough for 45 days of storage whereas mould growth was observed already after 11 days of storage on tortillas prepared from dough with natamycin salt (irregular shaped crystals) in the dough.

TABLE 3
Mould growth on tortillas prepared with Ca-propionate,
natamycin needles and natamycin salt (irregular
shaped crystals) or no preservative (blanc)

| | | | 20 ppm | |
|---|---|---|---|---|
| | | | Delvo ®Cid + | 20 ppm |
| Days of | | 0.3% Ca- | 07015 | Delvo ®Cid |
| storage | Blanc | propionate | Natamycin needles | Natamycin salt |
| 11 | + | − | − | + |
| 15 | ++ | − | − | ++ |
| 18 | +++ | − | − | ++ |
| 21 | +++ | − | − | +++ |
| 29 | +++ | − | − | +++ |
| 36 | +++ | − | − | +++ |
| 45 | +++ | − | − | +++ |

−: No mould growth;
+: one spot of moulds;
++: several spots of moulds:
+++ severely covered with moulds

### Example 2. Shelf Life of Sponge Cakes Prepared from Dough with Natamycin Needles in the Dough

Cake doughs (batters) were prepared by mixing the ingredients disclosed in Table 4 including one of the following preservatives: 0.12 w/w % potassium sorbate, Delvo®Cid+07107, dosed at 15 or 20 ppm natamycin on batter weight. No preservative was added for the blanc.

TABLE 4
Ingredients of sponge cake

| Raw material | wt % |
|---|---|
| Wheat flour | 20.6 |
| Water (20^{°} C.) | 9.1 |
| Egg (4^{°} C.) | 29.7 |
| Castor sugar | 28.6 |
| Native wheat starch | 8.0 |
| Batter stabilizer BV40 | 3.0 |
| Sodium bicarbonate | 0.41 |
| Sodium acid | 0.57 |
| pyrophosphate (Levall 28) | |

The cake batters were mixed with a Hobart mixer: 1 min at first speed, 8 min at third speed and 1 min at first speed. 175 g of the batter was put in an aluminium round tray of 15 cm and the cakes were baked at 1952° C. top heat and 1852° C. bottom heat for 22 min. After baking the cakes were cooled at room temperature for 60 min. Each cake was covered with 0.125 g of flour to mimic possible contamination in a bakery and the cakes were packed in a plastic bag and stored at room temperature. Mould growth was visually inspected in time without opening the bags.

The results in Table 5 show that a composition comprising 15 and 20 ppm natamycin needles in the sponge cakes increased the shelf life to at least 21 days.

TABLE 5
Mould growth on sponge cakes prepared with K-sorbate, and
natamycin needles at 15 and 20 ppm or no preservative

| | | | 15 ppm | 20 ppm |
|---|---|---|---|---|
| | | | Delvo ®Cid + | Delvo ®Cid + |
| Days of | | 0.12% | 07107 | 07107 |
| storage | Blanc | K-sorbate | Natamycin needles | Natamycin needles |
| 7 | − | − | − | − |
| 11 | − | − | − | − |
| 14 | − | − | − | − |
| 21 | +++ | − | − | − |
| 24 | +++ | + | + | − |
| 31 | +++ | ++ | ++ | + |
| 36 | +++ | +++ | ++ | ++ |
| 39 | +++ | +++ | ++ | ++ |

−: No mould growth;
+: one spot of moulds;
++: several spots of moulds:
+++ severely covered with moulds

### Example 3. Shelf Life of Sponge Cakes Prepared from Dough with Potassium (K) Sorbate, Natamvcin Needles and Natamvcin Salt in the Batter

Cakes were prepared as described in Example 2. The preservatives potassium sorbate (0.12 w/w %), natamycin needles (Delvo®Cid+07107, 20 ppm natamycin) and natamycin salt (Delvo®Cid, 20 ppm natamycin) all on batter weight were added to the cake batter. The blanc did not contain any preservatives. For each experiment half of the cakes (6 cakes per test) were covered with 0.75 g of flour per 6 cakes to mimic possible contamination in a bakery and the cakes were packed in a plastic bag. The cakes were stored at room temperature and mould growth was inspected visually in time without opening the bags.

The results in Table 6 show that cakes containing natamycin needles and natamycin salt did not show mold growth up to 43 days of storage. When the cakes were covered with flour, the cakes containing natamycin needles showed less mould growth than the cakes containing natamycin salt.

TABLE 6
Mould growth on sponge cakes prepared with K-sorbate, natamycin
needles and natamycin salt, or no preservative (blanc) with
and without addition of flour after baking the cake.

| | Days of storage | | | | |
|---|---|---|---|---|---|
| Preservative | 15 | 28 | 35 | 39 | 43 |
| K-sorbate | (0/6) − | (0/6) − | (2/6) ++ | (3/6) ++ | (3/6) ++ |
| | | | (0.3 cm) | (0.5cm) | (0.5 cm) |
| K-sorbate with flour* | (0/6) − | (2/6) ++ | (2/6) ++ | (4/6) +++ | (6/6) ++++ |
| | | (2 mm) | (0.5 mm) | (0.5cm) | (0.5 cm) |
| Blanc | (0/6) − | (2/6) + | (2/6) + | (2/6) ++ | (6/6) ++++ |
| | | (2 mm) | (0.5 cm) | (1 cm) | (0.5cm) |
| Blanc with flour* | (0/6) − | (1/6) + | (3/6) +++ | (6/6) +++ | (6/6) ++++ |
| | | (1 mm) | (0.2cm) | (0.2cm) | (0.5 cm) |
| Natamycin needles | (0/6) − | (0/6) − | (0/6) − | (0/6) − | (0/6) − |
| Natamycin needles | (0/6) − | (0/6) − | (2/6) ++ | (4/6) ++ | (4/6) ++ |
| with flour* | | | (0.2 cm) | (0.2 cm) | (0.2 cm) |
| Natamycin salt | (0/6) − | (0/6) − | (0/6) − | (0/6) − | (0/6) − |
| Natamyin salt with | (0/6) − | (0/6) − | (4/6) ++ | (6/6) +++ | (6/6) +++ |
| flour* | | | (0.2 cm) | (0.2 cm) | (0.2 cm) |

*0.75 g flour per 6 cakes applied after baking
(x/6) where x is the amount of cakes infected
Y mm or cm is the size of the moulds
− no moulds,
+ 1 mould per cake,
++ 2-5 moulds per cake,
+++ 5-10 moulds per cake,
++++ >10 moulds per cake

1. A process for preparing a non-yeast baked product comprising
i. preparing a dough comprising adding a composition comprising natamycin having needle shaped crystals to the dough wherein the mean length of the needle shaped crystals is from 0.1 to 20 μm; and
ii. baking the dough.

2. The process according to claim 1, wherein an amount of 1 to 50 ppm of natamycin is added to the dough.

3. The process according to claim 1, wherein the composition comprising natamycin is a water-containing suspension comprising natamycin.

4. The process according to claim 1, wherein the natamycin comprises at least 50 w/w %, 60 w/w %, 70 w/w %, 80 w/w %, 90 w/w %, or at least 95% w/w of needle shaped crystals.

5. The process according to claim 1, wherein the non-yeast baked product has a shelf life of at least 7 days.

6. The process according to claim 1, further comprising packaging the non-yeast baked product.

7. A non-yeast baked product obtainable by a process according to claim 1.

8. The non-yeast baked product according to claim 7, wherein the baked product does not comprise natamycin that has been applied onto the surface of the baked product.

9. A packaging comprising the non-yeast baked product according to claim 7.

10. A non-yeast dough comprising a composition comprising natamycin having needle shaped crystals in the dough wherein the mean length of the needle shaped crystals is from 0.1 to 20 μm in the dough.

11. A process for preparing a non-yeast dough comprising adding a composition comprising natamycin having needle shaped crystals to the dough wherein the mean length of the needle shaped crystals is from 0.1 to 20 μm.

12. A product comprising a composition comprising natamycin having needle shaped crystals to improve the shelf life of a non-yeast baked product wherein the mean length of the needle shaped crystals is from 0.1 to 20 μm, and wherein the composition is present in the non-yeast baked product.

13. The product according to claim 12, wherein the baked product does not comprise natamycin that has been applied onto the surface of the baked product.

14. The process according to claim 1, the non-yeast baked product thereof, packaging comprising said baked product, or a product comprising a composition comprising natamycin having needle shaped crystals to improve the shelf life of a non-yeast baked product wherein the mean length of the needle shaped crystals is from 0.1 to 20 μm, and wherein the composition is present in the non-yeast baked product, wherein the non-yeast leavened baked product is a cake, a muffin, a pastry, a waffle, and/or a flat bread, wherein the flatbread is optionally a pancake, a chemically leavened pizza, or a tortilla.
